(19) United States
(12) Patent Application Publication
(10) Pub. No.: US 2025/0004734 A1
(43) Pub. Date: Jan. 2, 2025

(54) METHOD, APPARATUS, AND COMPUTER-READABLE MEDIUM FOR MITIGATING NONCOMPLIANCE OF SOURCE CODE WITH INTERNATIONALIZATION AND LOCALIZATION REQUIREMENTS

(71) Applicant: INFORMATICA LLC, Redwood City, CA (US)

(72) Inventor: Vinay Kumar MISHRA, Bangalore (IN)

(21) Appl. No.: 18/215,553

(22) Filed: Jun. 28, 2023

(51) Int. Cl. G06F 8/51; G06F 8/41; G06F 8/71

(52) U.S. Cl. CPC G06F 8/51; G06F 8/437; G06F 8/443; G06F 8/71

(57) ABSTRACT

An apparatus, computer-readable medium, and computer-implemented method for mitigating noncompliance of source code with internationalization and localization (i18N) requirements including compiling target source code to generate target assembly code, parsing the target assembly code to identify first instructions corresponding to non-externalized string values based on first operation codes associated with the first instructions, parsing the target assembly code to identify second instructions corresponding to Application Programming Interface (API) signatures based on second operation codes associated with the second instructions, determining whether at least one first instruction does not comply with the i18N based on the non-externalized string values, determining whether at least one second instruction does not comply with the i18N requirements based on a valid API repository and the API signatures, and executing a mitigation action on the source code based on a determination that the first instructions or the second instructions do not comply with the i18N requirements.

### BACKGROUND

Internationalization and localization processes, referred to as i18N, are processes and practices used to create globalized products that can expand the product portfolio to different countries and languages. Internationalization is the process of designing a software that can be adapted to various languages and regions without engineering changes. Additionally, localization is the process of adapting internationalized software for specific regions or languages by translating text and adding localized features.

A variety of different data structures, functions, and items of data contain culturally dependent information. For textual or string data, this information must be externalized, meaning the string must be loaded from an external source (e.g., a database of localized strings for different locales), otherwise the same string will be displayed in all geographic areas. Additionally, Application Programming Interface (API) calls may vary from region to region, and the correct APIs must be utilized for function calls. Examples of data value that require i18N processes for localization include messages, labels on GUI components, online help, sounds, colors, graphics, icons, dates, times, numbers, currencies, measurements, phone numbers, honorifics and personal titles, postal addresses, page layouts.

There are several challenges to implementing i18N and negative effects from not properly implementing i18N in the software deployment environment. In particular:
One challenge is that there are no systems that allow for automated detection of i18N issues and enforcement of i18N guidelines in the software development framework in most of the industry. In particular:
There are no systems for identifying non-externalized string in software code, including for delta changes or as a backlog and making sure the code complies with i18N requirements at the earliest software development lifecycle (SDLC) stages (e.g., prior to check-in of code).
There are no systems for identifying the usage of APIs signatures and validating API signatures in code against valid i18N repositories to ensure that he API calls adhere to i18N standards\guidelines at the earliest SDLC stages (e.g., prior to check-in of code in a source code management tool during the review process).
Current solutions, such as manual or semi-automated review, are programming language specific, and cannot be utilized across a broad range of programming languages (C, C++, JVM types, Python, JS etc) with a generic solution of CIL (Opcode analysis).
There are no systems utilizing centralized i18N repositories that can be used to identify and correct i18N issues.
There are no solutions that are available that have a feedback mechanism process for updating the false positive cases identified, back to the system, so that subsequent executions will skip these identified issues.

Accordingly, there is a need for improvements in systems and methods for identifying and mitigating noncompliance of source code with internationalization and localization requirements.

### BRIEF DESCRIPTION OF THE DRAWINGS

FIG. 1 illustrates a sample structure of Java bytecode (assembly code).

FIG. 2 illustrates a flowchart for mitigating noncompliance of source code with internationalization and localization requirements according to an exemplary embodiment.

FIG. 3A illustrates an example of assembly code generated from source code according to an exemplary embodiment.

FIG. 3B illustrates another example of assembly code generated from source code according to an exemplary embodiment.

FIG. 4A illustrates a flowchart for compiling target source code to generate target assembly code in an initial flow according to an exemplary embodiment.

FIG. 4B illustrates a flowchart for compiling target source code to generate target assembly code in an update flow according to an exemplary embodiment.

FIG. 5 illustrates a flowchart and example for parsing the target assembly code to identify one or more first instructions corresponding to one or more non-externalized string values according to an exemplary embodiment.

FIG. 6 illustrates a flowchart and example for parsing the target assembly code to identify one or more second instructions corresponding to API signatures according to an exemplary embodiment.

FIG. 7 illustrates a flowchart for determining whether at least one first instruction in the one or more first instructions does not comply with the internationalization and localization requirements based at least in part on the one or more non-externalized string values according to an exemplary embodiment.

FIG. 8 illustrates a process flow diagram of determining whether at least one first instruction in the one or more first instructions does not comply with the internationalization and localization requirements based at least in part on the one or more non-externalized string values according to an exemplary embodiment.

FIG. 9 illustrates an example of assembly code having an API call and the output when the API call complies with i18N requirements and when the API call does not comply with i18N requirements according to an exemplary embodiment.

FIG. 10 illustrates a flowchart for determining whether at least one second instruction in the one or more second instructions does not comply with the internationalization and localization requirements based at least in part on a valid API repository and the one or more API signatures.

FIG. 11 illustrates an example of assembly code parsing and processing according to an exemplary embodiment.

FIG. 12 illustrates a flowchart for executing a mitigation action on the source code according to an exemplary embodiment.

FIG. 13 illustrates a system chart of a system for mitigating noncompliance of source code with internationalization and localization requirements according to an exemplary embodiment.

FIG. 14 illustrates the components of the specialized computing environment for mitigating noncompliance of source code with internationalization and localization requirements according to an exemplary embodiment.

### DETAILED DESCRIPTION

While methods, apparatuses, and computer-readable media are described herein by way of examples and embodiments, those skilled in the art recognize that methods, apparatuses, and computer-readable media for mitigating noncompliance of source code with internationalization and localization requirements are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

As explained above, current systems for i18N compliance involve building a product and delivering the product to a quality assurance team to validate the source code manually and a source code level. This process is time consuming and inefficient, as it requires additional configuration overhead and manual review by the quality assurance team. This review requires access to high level source code, which can raise security or compliance issues. Furthermore, since each high-level programming language is unique, the process of i18N review can vary from language to language. Additionally, as many new platforms\languages and coding standards are always in development and put to use, existing techniques must be continually revised for new technologies, programming languages, and standards.

Applicant has invented a novel method, apparatus, and computer-readable medium for identification and mitigation of noncompliance of source code with internationalization and localization requirements that solves the above-stated problems.

As will be explained in greater detail below, the present solution operates on compiled code, also referred to herein as assembly code, common interface language, object code, opcode, or bytecode. Since the solution is high-level programming language agnostic, it can be applied to a variety of high-level languages through analysis of compiled code.

The present solution also has the benefit of identifying i18N issues early in the SDLC, prior to check-in of the code, e.g., in a source code management (SCM) tool during the review process. Since the solution works prior to check-in, it limits downstream effects of i18N noncompliance and backlogs of i18N issues that need to be addressed.

In the event that i18N issues are identified, mitigating actions can be taken. For example, developers can be barred from checking in code at the code check-in stage by the SCM tool. The proposed solution can be also be utilized with many different languages, including Java, Scala, Groovy, C, C++ code, and/or other programming languages.

The present solution also utilizes centralized i18N repositories to identify and correct i18N issue. These repositories include an API signature repository, an exception repository, a context repository, and a rules repository.

The API signature repository can be scanned or looked up to identify if a given API at code follows an i18N standard. The present system also utilizes a loop back system that can add additional standard or new APIs to the base repository. This repository can be used by and contributed to by the organization which is utilizing the present system.

The exception repository and the context repository can be used to identify if a method or statement in code is fit for further scanning or if it can be removed from consideration as a potential i18N issue. A feedback loop can also be utilized to add more exceptions and context rules to the exception repository and the context repository, for example, in response to user input as the system detects and flags potential i18N issues. This repository can be used by and contributed to by the organization which is utilizing the present system.

The rules repository can be scanned and queried to identify if a given string literal in code is a legitimate string that is non externalized or not. A feedback loop can also be utilized to add new rules to the rules repository in response to user or administrator feedback or input.

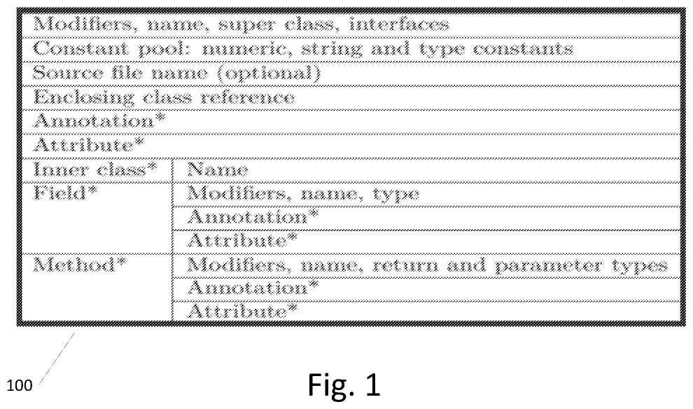

A major advantage of the proposed solution via assembly language/opcode is that it covers all aspects of the problems described. The solution utilizes common interface language (CIL)\opcode, like bytecode or assembly code, that has a well-structured and readable format, particularly compared to source code (that has lots of formatting and beautifications) and machine code, that is mostly in 00 and 11 chars. FIG. 1 illustrates a sample structure of Java bytecode (assembly code). As shown in FIG. 1, the Java bytecode has a defined format and fields.

Prior to explaining the present solution in greater detail, a brief of summary of alternative solutions is presented below, along with the drawbacks of the alternative solutions.

One alternative solution is to search for string patterns and exclude the language exceptions via direct source code file search for double quoted strings and API signatures that are nonstandard. The drawbacks of this solution are:
language specific code and many code writing\framework patterns to be considered;
complexity in the code and string literal usage (via enums, Fields, variable, etc.), code expanded to multiple lines, and lines contains multiple strings;
annotations and comment lines are overhead if double quoted strings are used;
fetching the methods usage and signature and validating it against the standards is a tedious process;
fails if the string literals\double quoted strings are not handled in regular ways (line wrapping).

Another alternative option would be to try and use lexical analysis or a lexical analyzer to identify, for example, non-externalized strings. This option also has a number of drawbacks, including:
language specific processes all would require different regular expressions and each language requires utilizes different APIs;
appropriate terms and conditions may not be known for many libraries and there is no single solution that can be used to identify i18N issues;
method/API signature definition identification is a complex and tedious process, and difficult to implement while performing lexical parsing;
a generic solution cannot be implemented for all types of code;
in certain environments, runtime resolution of data-types is not feasible prior to compilation; and
lexical analysis is focused primarily on syntax rather than i18N related issues;

As shown above, alternative approaches suffer from a number of drawbacks and are not able to address i18N detection and mitigation issues in different types of source code. The proposed solution parses and analyzes common interface languages (CIL), such as bytecode or assembly code, to detect and mitigate i18N issues. The proposed approach has the following benefits:
CIL/bytecode/assembly code, also termed portable code, is a form of instruction set that is designed for efficient execution by a software interpreter;
assembly code/bytecode is language independent (Java\Scala\Groovy) for Java Virtual Machine (JVM) types or C++ or C for assembly code;
constant pool and literal data sets and other Op Codes (operation codes) in the assembly code give a complete list of string and API signatures used in the code file for JVM supporting languages. Similar operation codes are available for assembly language-based code bases;
CIL ignores noise in the code by default, such as comments in the source code;
the solution can be efficiently implemented and deployed as it involves parsing assembly code and parsing assembly operation codes (“OpCodes”).

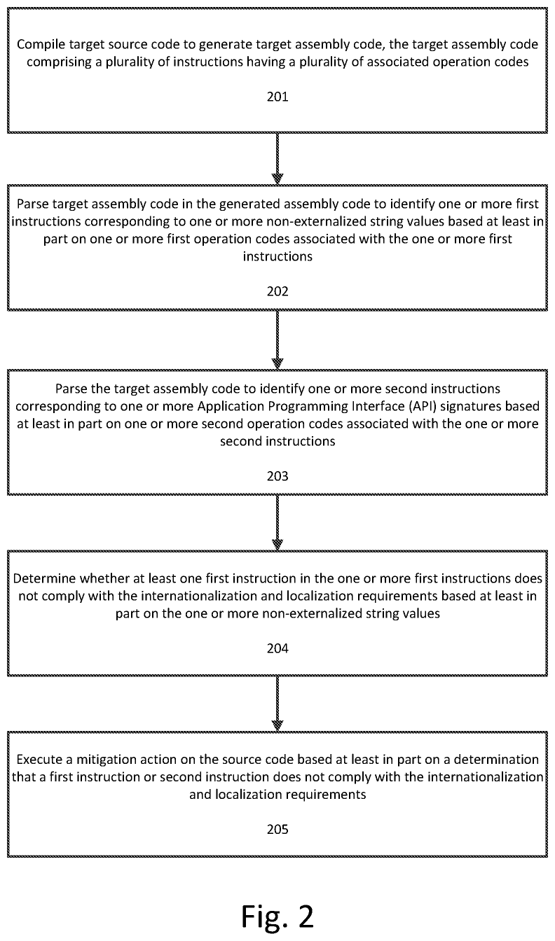

FIG. 2 illustrates a flowchart for mitigating noncompliance of source code with internationalization and localization requirements according to an exemplary embodiment. The process shown in FIG. 2 can be performed in software development environment, for example, when source code is submitted for check-in in a by a developer, but prior to actual check-in of the code.

At step 201 target source code is compiled to generate target assembly code, the target assembly code comprising a plurality of instructions having a plurality of associated operation codes. The target source code can be any type of source code, such as Java, Scala, C, C++, etc. Additionally, as used herein, assembly code refers to compiled code and includes assembly language instructions, bytecode, object code, or any other type of compiled code.

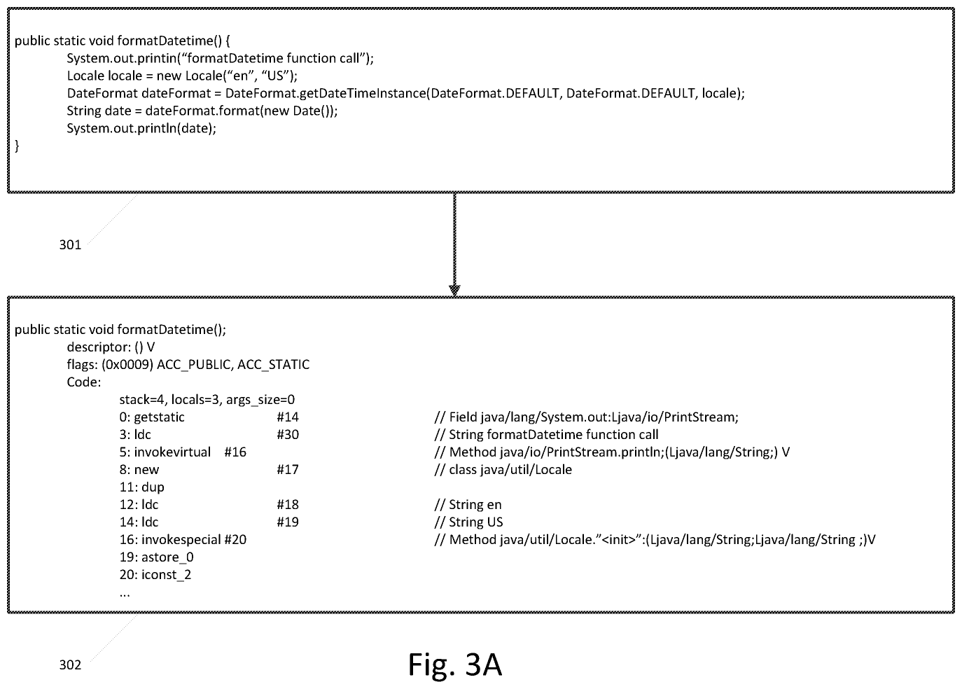

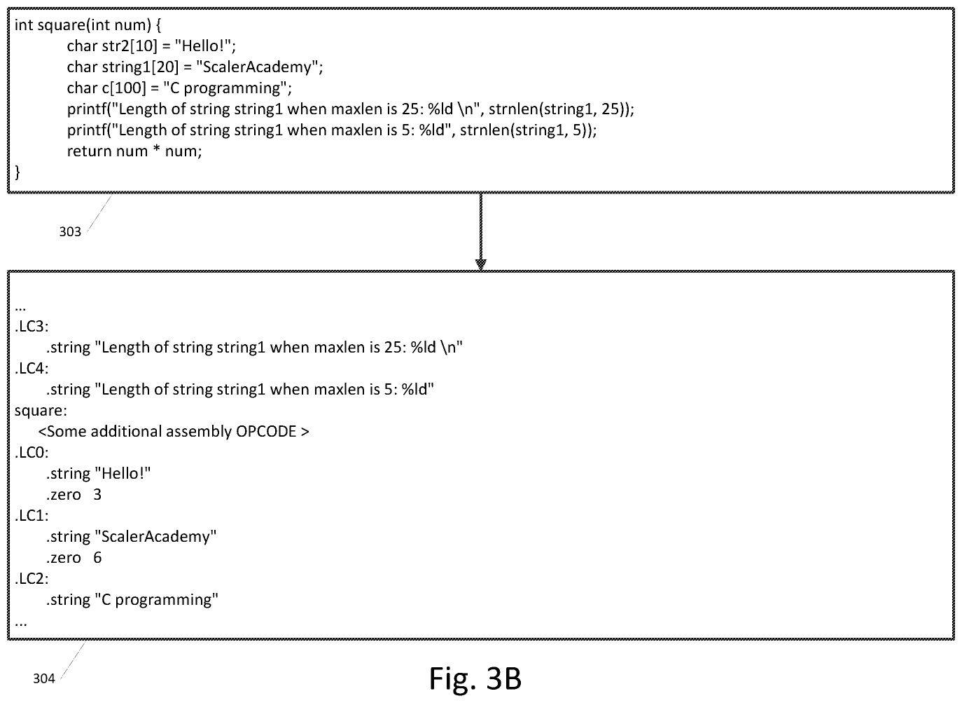

FIG. 3A illustrates an example of assembly code generated from source code according to an exemplary embodiment. Box 301 illustrates Java source code and box 302 illustrates a portion of the assembly code that is generated by compiling the Java source code in box 301. FIG. 3B illustrates another example of assembly code generated from source code according to an exemplary embodiment. Box 303 illustrates C++ source code and box 304 illustrates a portion of the assembly code that is generated by compiling the C++ source code in box 303.

The target source code can correspond to the entirety of a source code library or file, or can correspond to a portion of a source code library. For example, the target source code can correspond to changes or revisions made since a previous version, commit, or check-in of source code in a source code management tool during the review process.

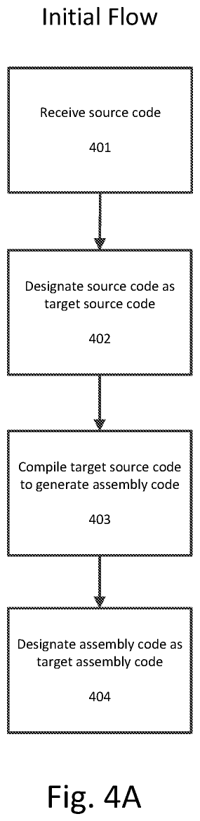

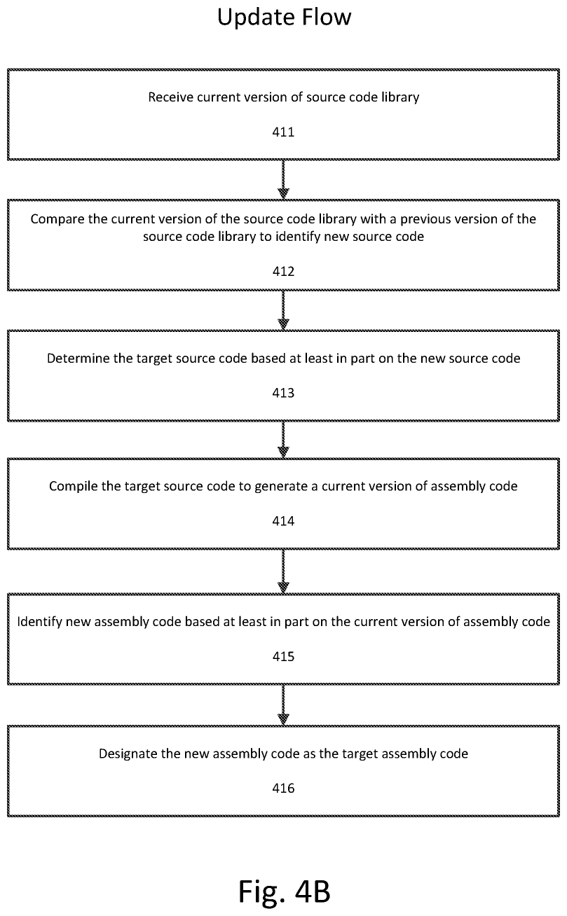

FIG. 4A illustrates a flowchart for compiling target source code to generate target assembly code in an initial flow according to an exemplary embodiment. The process shown in FIG. 4A can be performed the first time a particular item of source code (e.g., files, libraries, etc.) is received. At step 401 the source code is received. At step 402 the received source is designated at the target source code. At step 403 the target source code is compiled to generate assembly code. Additionally, at step 404 the generated assembly code is designated as the target assembly code.

The initial flow can be used for identification of i18N issues such as non-externalized strings and non-compatible API usage on an entire project. This option is usually utilized when the source code is being applied/submitted for the first time in any project. This flow can be used define the i18N quality debt in the code and initial issues. Based on the issues and severity of the i18N issues, the development team can plan for the fix or can ignore the set of failures (e.g., labelled as false positives). All the false positives can be added to the system as a new RULE and can be used for subsequent analysis of source code submissions.

FIG. 4B illustrates a flowchart for compiling target source code to generate target assembly code in an update flow according to an exemplary embodiment. The update flow can be performed when updated source code is received after the initial flow and can be used to identify and/or mitigate i18N issues in changed or new portions of source code. The update flow validates the delta changes in the code to make sure that only changed lines of code are being validated against the i18N standard and guidelines.

For both the initial flow (FIG. 4A) and the update flow (FIG. 4B), a setup initializer is used to identify code in a code repository that has changed or new source code files and/or detect when a developer has submitted source and then trigger downstream steps. The Algorithm 1 Pseudocode, shown below, identifies details including the change list and developer information regarding developers that implement changes. For reference, Perforce is a source code management tool. The developer will not be able to check-in code unless all the stages in the process shown in FIG. 2 are completed and no potential i18N externalization issues are being identified. The change list and other metadata are passed as arguments to next stage. For the initial flow, this can be a step to initiate the process by triggering the system via any command line arguments\API calls(HTTPs or Rest) to Jenkins servers (an orchestration tool used to manages all automation and build Jobs).

Algorithm 1 Pseudocode:

| | |
|---|---|
| 1. | Two steps here: |
| 2. | STEP1 |
| 3. | Remote invocation via CURL\HTTPs to Jenkins JOB_NAME: ARGUMENT: |
| | CLname #CLname is Change List number that has code updated and send for review by |
| | Dev via Swarm review process( in case of Perforce). CLname is a condition for flow2. |
| | For flow1, it's a remote build trigger |
| 4. | STEP2 #for Update Flow only |
| 5. | Script(#Pseudocode) in Current Shell,#ARGUMENT $CLname Type Int |
| 6. | import Python libs #This is to setup the libs to parse and compare the |
| | arguments |
| 7. | ValidateChangelistdata($CLname) #Validate the CLname content |
| 8. | STOP in case $CLname format and value is not valid. #Check done |
| | via perforce or Git commands |
| 9. | Print “ Error” |
| 10. | exit |
| 11. | return $CLname #If all good above |

Referring to the update flow of FIG. 4B, at step 411 a current version of a source code library is received. The current version of the source code can be submitted by a developer, along with any supporting libraries or updated files.

At step 412 the current version of the source code library is compared with a previous version of the source code library to identify new source code. This step can include comparing the text and lines of the current version of the source code library with the text and lines of the previous version of the source code library to identify new lines and text or text that has been changed relative to a previous version.

This step identifies the file and the module that is changed in the code and the information is passed to next stage. Algorithm 2 Pseudocode, reproduced below, can be used to perform this step.

Algorithm 2 Pseudocode:

| | |
|---|---|
| 1. | Script (@Pseudocode) in Previous shell #ARGUMENT $CLname Type |
| | Int |
| 2. | IdentifyImpactedModule($CLname) |
| 3. | List all affected files in $CLname. # Store in variable |
| | $effected_files |
| 4. | loop $effected_files for each $effected_files_entry # Each of |
| | the effected files has the full path till depots that contains even the |
| | component and module information. |
| 5. | In $effected_files_entry, file source path, identify the |
| | modules and components that the files belong to #Store in variable |
| | $impacted_module_names |
| 6. | #Below loop will identify if there are any impacted modules |
| | w.r.t all items at #variable $impacted_module_names |
| 7. | #This will be used during the build time as all the impacted |
| | module also has to be build. lookup will be done on a master list created |
| | earlier in system and stored, Lookup data say will be stored in |
| | Master.properties file( contains data in format like |
| | modulenameA=ModulenameB, ModulenameC, where it states that |
| | ModulenameA has dependency on ModulenameB and ModuleNameC. |
| | Similar entries will be there for all the modules. |
| 8. | loop $ impacted_module_names |
| 9. | Identify the all dependent modules(direct or indirect) |
| | and add to a new list. # Strore in data in Variable |
| | $Impacted_dependent_modules |
| 10. | merge $Impacted_dependent_modules and |
| | $impacted_module_names # Store to variable $modules_to_compile |
| 11. | return $modules_to_compile # This contains data of all the modules that |
| | are Change by dev, and all its dependent modules, all this list is going to |
| | be compiled in next steps. |

At step 413 the target source code is determined based at least in part on the new source code. The target source code can correspond to changed or new lines of source code, but can also include any additional source code required for successful compilation of the current version of the source code.

This step can include identifying the lines that have been changed by the developer and pushing these changed lines to a temporary file called (“TEMPA.out”) or into a global variable. Algorithm 3 Pseudocode, reproduced below, can be used to accomplish this sub-step. This data can also be stored in global variables or a serialized data at storage disk.

Algorithm 3 Pseudocode:

| | |
|---|---|
| #1 | Script( @Pseudocode) in Previous shell #ARGUMENT $CLname Type |

Int and $workspace as String

| | |
|---|---|
| #2 | IdentifyChangedline($CLname and $workspace) |
| #3 | Run p4 or git command to identify the changed lines in |

the $CLname# Store in Variable $updatedlines_cl eg : p4 describe -ds #CLname,
this is for perforce and similar command are avalable for git.

| | |
|---|---|
| #4 | #Store the above data in a list, this contains all Changed |

lines, Edit, Delete, added and we need to worry about only Edited and Added
lines to see if any new potential non externalization string is added by devops.

| | |
|---|---|
| #5 | loop $updatedlines_cl variable #To filter only the Edit |

and Added lines.

| | |
|---|---|
| #6 | if $updatedlines_cl contains Edit or Add suffices. |
| #7 | Store in $filterlines_toconsider |
| #8 | |
| #9 | return $filterlines_toconsider #This data can be stored in temp file |

TempA.out for further lookup

At step 414 the target source code is compiled to generate a current version of assembly code. In this step, the changed modules and all related and dependent modules are compiled via a build process. The output, including the class files\object files and the class files that have impacted the code, is passed to the next step as arguments. Algorithm 4 Pseudocode, reproduced below, can be used for this step.

Algorithm 4 Pseudocode:

| | |
|---|---|
| 1. | Script( @Pseudocode) in Previous shell #ARGUMENT $modules_to_compile Type List |
| 2. | CompileChangedModule($modules_to_compile) |
| 3. | Create new workspace folder #Run below steps in same workspace. |
| 4. | Sync the required build tools and set the build enviornment that is required |
| | #Like JDK, Maven or gradle, make files or so |
| 5. | Sync all the source files in local workspace created above. #Syn is done |
| | from perforce or Github |
| 6. | loop $modules_to_compile |
| 7. | Build modules, # Build all the modules and its dependenties in a |
| | single reactor using the tool |
| 8. | # if Failure due to comilation error exit. |
| 9. | exit |
| 10. | #In case the loop ends without failure, then gather the compiled version of |
| | code and form a list. |
| 11. | loop at workspace and collect all the files with compiled version #Say .class for |
| | Java, these files will be used to create bytecode. |
| 12. | Get the effected class files |
| 13. | zip file and send it for next level. #Store to artifacts to temp locations like |
| | NFS\S3\blob, so that next level of job can pick it up. Share the location, variable |
| | $zipCompiledfilelocation |
| 14. | return $zipCompiledfilelocation |

At step 415 new assembly code is identified based at least in part on the current version of assembly code. This step can be performed by comparing the current version of assembly code with a previous version of assembly code corresponding to the previous version of the source code library to identify new assembly code. The new assembly code corresponds to the new and/or changed target source code.

The new assembly code can additionally or alternatively be determined by identifying which lines of assembly code correspond to new or changed lines of target source code. For example, a line number table can be generated with the assembly code. The line number table can be a parameter in the assembly that maps the source code with statements in assembly code. This allows the system to map changed or new lines in the current version of the source code to assembly code and performed the required analysis only on those lines.

During compilation, the entire project, including relevant source code files and classes, are all compiled. To determine new assembly code, a temporary output file (“TEMPB.out”) is created for each class file. Processing can then proceed in parallel for each of the output files.

As explained above, this step can generate the assembly code/bytecode from the class files and store the output in new temp files called TEMPB.out. These files are passed as arguments to next stage. Algorithm 5 Pseudocode, reproduced below, can be used for this step.

Algorithm 5 Pseudocode:

| | |
|---|---|
| 1. | Generate bytecode(CIL) for all the class files generated above. |
| 2. | Script( @Pseudocode) in Previous shell #ARGUMENT |
| | $zipCompiledfilelocation Type String |
| 3. | GenerateBytecode($zipCompiledfilelocation) |
| 4. | List all files at $zipCompiledfilelocation |
| 5. | Loop List @zipCompiledfilelocation. |
| 6. | Copy to temp directory |
| 7. | << Specific to JVM specific code base, need to run the similar commands |
| | for JS and C++>>, Store the data to TEMPB.out, each class files, will |
| | have its own TEMPB.out |
| 8. | Run command to generate bytecode for each |
| | class file #for Java javap -p -l -v <Class filename>> |

At step 416 the new assembly code is designated as the target assembly code. The target assembly code is then analyzed as described further below.

Referring to FIG. 2, at step 202 the target assembly code is parsed to identify one or more first instructions corresponding to one or more non-externalized string values based at least in part on one or more first operation codes associated with the one or more first instructions. As discussed earlier, non-externalized string values are strings in quotations rather than variables or other data structures that can be adjusted according to i18N requirements.

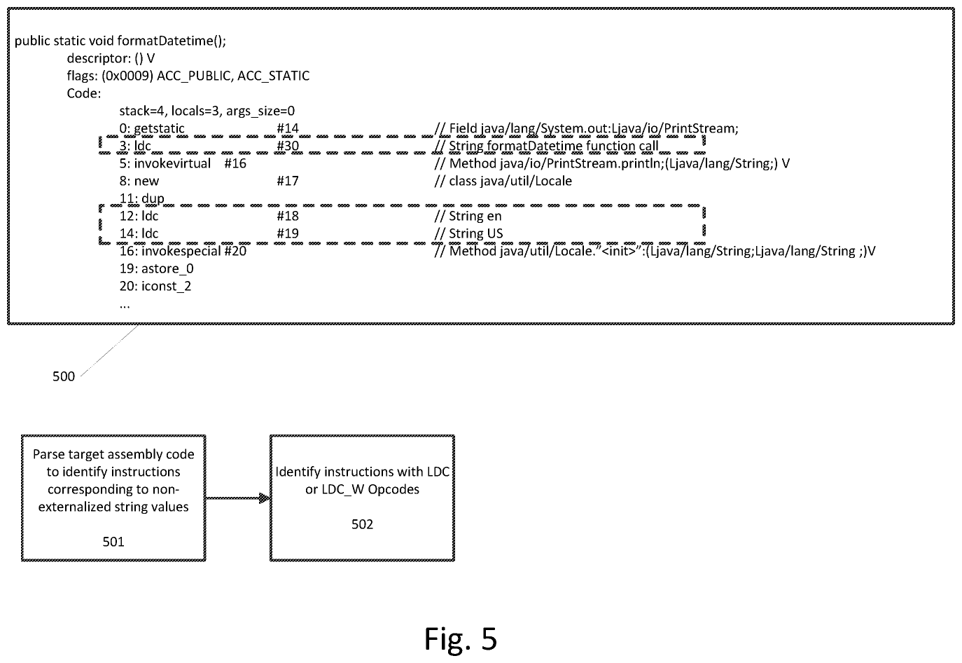

FIG. 5 illustrates a flowchart and example for parsing the target assembly code to identify one or more first instructions corresponding to one or more non-externalized string values according to an exemplary embodiment. As shown in FIG. 5, the step 501 of parsing the target assembly code to identify one or more first instructions corresponding to one or more non-externalized string values can include the step 502 of identifying instructions in the target assembly code that include the LDC or LDC_W operation codes. Box 500 illustrates an example of assembly code (bytecode) with instructions corresponding to non-externalized string values being shown in dashed rectangles. As shown in the figure, each of the instructions in dashed rectangles includes the LDC operation codes. Of course, different operation codes can be used to identify non-externalized strings for other types of assembly code. For example, assembly code compiled from C++ can be parsed to identify instructions having different operation codes or particular sequences of characters corresponding to non-externalized strings.

At step 203 of FIG. 2 the target assembly code is parsed to identify one or more second instructions corresponding to one or more Application Programming Interface (API) signatures based at least in part on one or more second operation codes associated with the one or more second instructions.

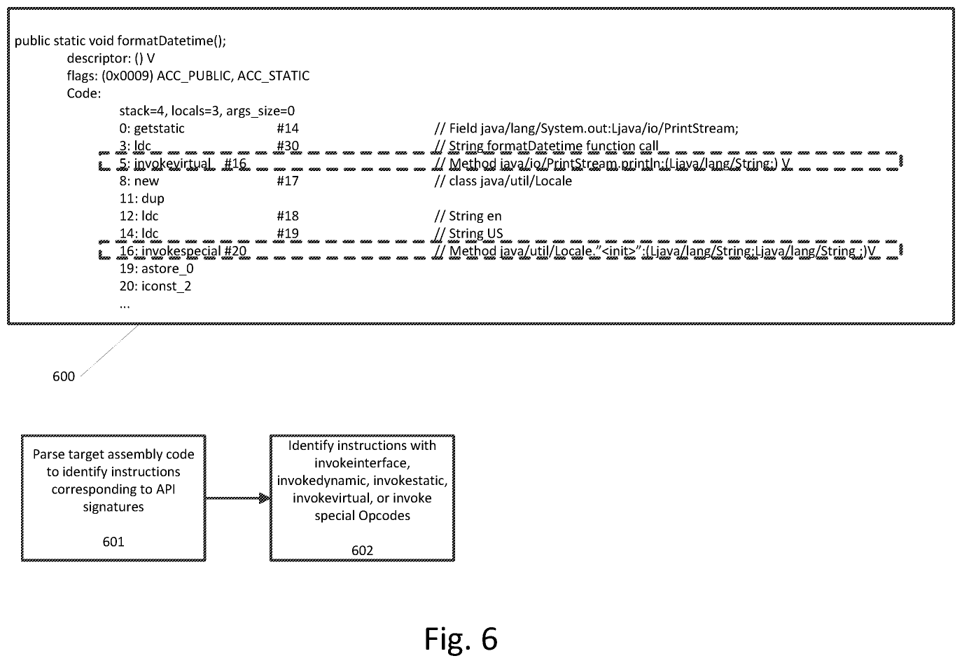

FIG. 6 illustrates a flowchart and example for parsing the target assembly code to identify one or more second instructions corresponding to API signatures according to an exemplary embodiment. As shown in FIG. 6, the step 601 of parsing the target assembly code to identify one or more second instructions corresponding to API signatures can include the step 602 of identifying instructions in the target assembly code that include the invokeinterface, invokedynamic, invokestatic, invokevirtual, or invokespecial operation codes. Box 600 illustrates an example of assembly code (bytecode) with instructions corresponding to API signatures being shown in dashed rectangles. As shown in the figure, the instructions in dashed rectangles includes the invokevirtual and invokespecial operation codes. Of course, different operation codes can be used to identify non-externalized strings for other types of assembly code. For example, assembly code compiled from C++ can be parsed to identify instructions having different operation codes or particular sequences of characters corresponding to API signatures.

At steps 202-203, the system processes the output of previous stage, such as TEMPB.out and gets the required data from it. The output of these steps can be the Object files that contain the string/literal information that are non-externalized and an another Object file that contains the API/method signatures that are actual methods called in code with its argument and return type. For the Update Flow, the changed lines in the TEMPB.out can be identified by comparing the file with the content from the TEMPA.out file. Optionally, rather than temporary files, the user can chose the global variables. For the Initial Flow, all the lines that are part of the assembly file can be considered.

Referring to FIG. 2, at step 204 a determination is made regarding whether at least one first instruction in the one or more first instructions does not comply with the internationalization and localization requirements based at least in part on the one or more non-externalized string values.

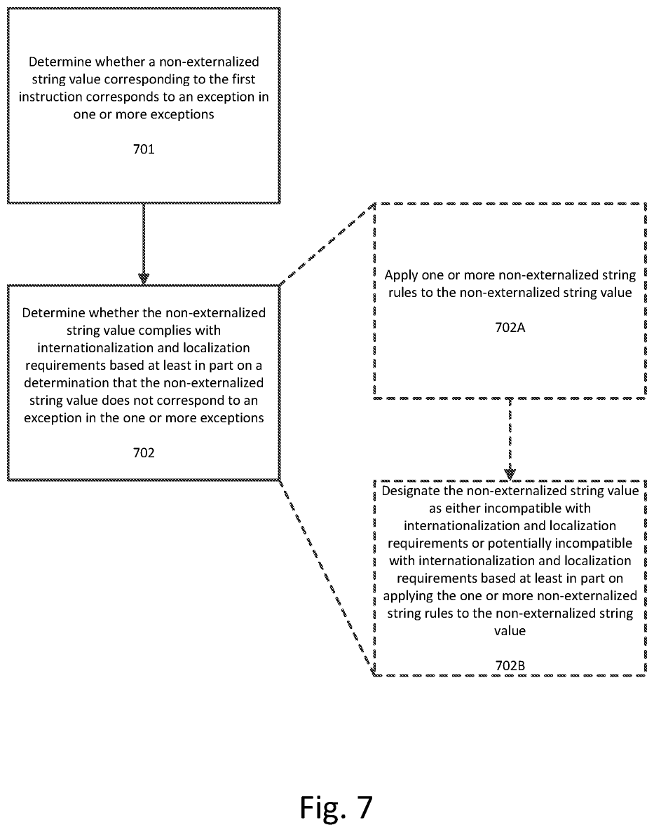

FIG. 7 illustrates a flowchart for determining whether at least one first instruction in the one or more first instructions does not comply with the internationalization and localization requirements based at least in part on the one or more non-externalized string values according to an exemplary embodiment. The steps in FIG. 7 can be performed each first instruction in the one or more first instructions.

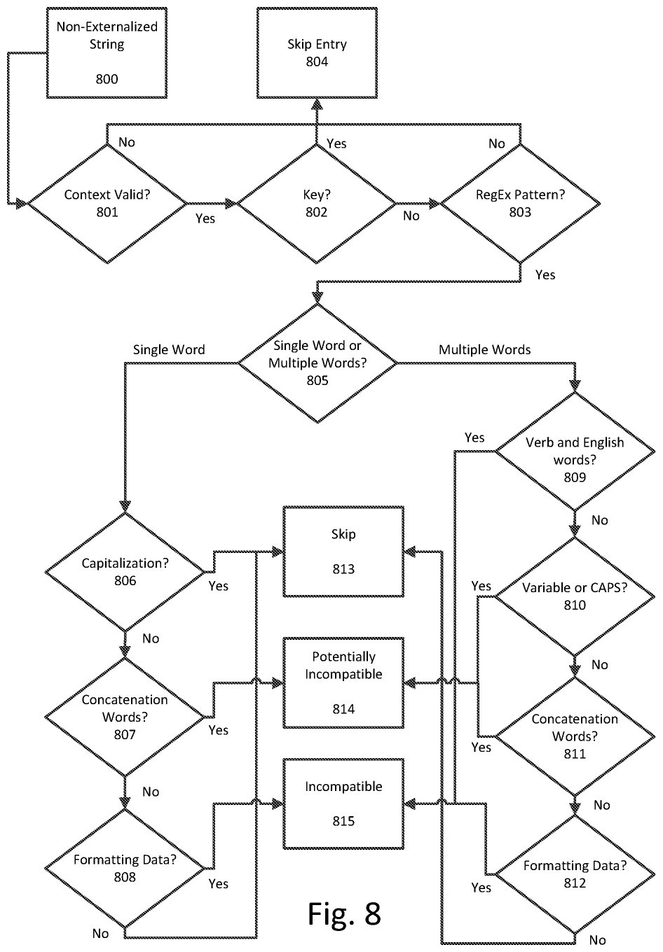

At step 701 a determination is made regarding whether a non-externalized string value corresponding to the first instruction corresponds to an exception in one or more exceptions. This step is explained in greater detail with respect to steps 801-803 of FIG. 8.

At step 702 a determination is made regarding whether the non-externalized string value complies with internationalization and localization requirements based at least in part on a determination that the non-externalized string value does not correspond to an exception in the one or more exceptions.

Step 702 can include sub-steps 702A and 702B. At sub-step 702A one or more non-externalized string rules are applied to the non-externalized string value. This sub-step is explained in greater detail with respect to steps 805-812 of FIG. 8.

At sub-step 702B the non-externalized string value is designated as either incompatible with internationalization and localization requirements or potentially incompatible with internationalization and localization requirements based at least in part on applying the one or more non-externalized string rules to the non-externalized string value. This sub-step is explained in greater detail with respect to steps 813-815 of FIG. 8.

FIG. 8 illustrates a process flow diagram of determining whether at least one first instruction in the one or more first instructions does not comply with the internationalization and localization requirements based at least in part on the one or more non-externalized string values according to an exemplary embodiment.

Non-externalized string 800 is passed into the process. At step 801 a determination is made regarding whether the context of the non-externalized string is a valid i18N context. This step can be performed by comparing fields, attributes, or other characteristics associated with the non-externalized string with valid contexts indicated in a context repository, described in greater detail below. Valid i18N contexts can include messages, labels on GUI components, online help, sounds, colors, graphics, icons, dates, times, numbers, currencies, measurements, phone numbers, honorifics and personal titles, postal addresses, and/or page layouts. Certain fields and areas can be designated as not being relevant to i18N compliance. For example, a company may indicate that strings associated with log messages are not pertinent to i18N compliance and may disregard these strings.

If the context is not a valid context, then the non-externalized string entry can be skipped at step 804. Otherwise, at step 802 a determination is made regarding whether the non-externalized string is a key. In this step the system checks whether the non-externalized string is already defined as key in the project resource bundle. If the non-externalized string is defined as a key, then the non-externalized string entry can be skipped at step 804. Otherwise, the process proceeds to step 803.

At step 803, a determination is made regarding whether the non-externalized string matches certain regular expressions corresponding to non-i18N use cases. This step can include checking whether the non-externalized string matches patterns such as com.*, com/*, .*[ ]from[ ].*[ ]where[ ].*, \hat{ }sendHttpRequest.*, \hat{ }.*java[.].*$, \hat{ }class.*$, or other regular expressions. If the non-externalized string matches any regular expressions, then the non-externalized string entry can be skipped at step 804. Otherwise, the process proceeds to step 805.

Note that steps 801-803 all correspond to the exception determination step 701 of FIG. 7 and the context data for step 801, key data for step 802, and regular expressions for step 803 can all be retrieved from an exceptions repository, described below in greater detail.

At step 805 a determination is made regarding whether the non-externalized string contains a single word or multiple words. A different set of rules can be applied to single word strings versus multiple word strings, as discussed below. If the non-externalized string contains multiple words, then the process proceeds to step 809. If the non-externalized string contains a single word, then the process proceeds to step 806.

At step 809 a determination is made regarding whether the non-externalized string contains a verb and all English words. Examples include “Mass Ingestion Alerts” or “Rule not enabled because of internal error. Contact Administrator.” This step can be performed by performing natural language processing (e.g., parsing, stemming, etc.) of the string and comparing the substrings to known verbs in a dictionary. If the string has all English works along with one or more verbs, and it is not externalized, then it very likely does not comply i18N requirements. In this case, the process proceeds to step 815 and the non-externalized string is flagged as incompatible with i18N requirements. Otherwise, if the string does not contain all English words and/or does not contain a verb, then the process proceeds to step 810.

At step 810 a determination is made regarding whether the non-externalized string includes a variable or capitalization. An example of this is “select at least ONE email recipient.” This example contains one capitalized substring in between other substrings (ONE), and according to standard, a CAPS character does not get translated here, since the string “ONE” is capitalized and in the flow of a sentence. Detection of a capitalized substring can be performed using appropriate natural language processing (NLP) techniques. Additionally, detection of a variable can be performed by comparing the substrings with a project information repository or similar structure storing variable names. In the scenario where the non-externalized string includes a variable or capitalization, it is possible that the developer has accidentally used capitalization or forgotten to use camel case. If the non-externalized string includes a variable or capitalization then the process proceeds to step 814 and the non-externalized string is flagged as potentially incompatible with i18N requirements. Otherwise the process proceeds to step 811.

At step 811 a determination is made regarding whether any words are concatenated within the non-externalized string. Examples of concatenated words within the non-externalized string include “Select at least ONE Rule_To_Apply” or “Select at least ONE RuleAppliesTo.” This step can include attempting to separate the non-externalized string into words (e.g., by delimeters and/or by word recognition). If a non-externalized string includes a concatenated string, there is a possibility that the developer accidentally concatenated the string. If the non-externalized string is found to include concatenated words, then the process proceeds to step 814 and the non-externalized string is flagged as potentially incompatible with i18N requirements. Otherwise the process proceeds to step 812.

At step 812 the system determines whether the non-externalized string includes any formatting data. An example of strings with formatting data include “MM:DD:YYYY,” and “$.” Any kind of hardcoded time, date, currency, and/or locale specific data necessarily triggers i18N requirements. If the non-externalized string includes formatting data, then the process proceeds to step 815 and the non-externalized string is flagged as incompatible with i18N requirements. Otherwise the process proceeds to step 813, indicating that the non-externalized string does not require any internationalization and localization adjustments.

Referring back to step 805, if the non-externalized string is found to have a single word, then the process proceeds to step 806. At step 806 the system determines whether the non-externalized string is a capitalized word. Examples include COLUMN, TABLE, SQL. Single capitalized words can be ignored for i18N purposes, since they cannot be externalized. If the non-externalized string is found to have a single capitalized word, then the process proceeds to step 813, and the non-externalized string is skipped from further analysis. If the (single) non-externalized string is not capitalized, then the process proceeds to step 807.

Step 807 is similar to step 811 except that it is applied to a single word non-externalized string. In this step a determination is made regarding whether any words are concatenated within the non-externalized string. Examples of concatenated words within a single word non-externalized string include “Rule_To_Apply” or “RuleAppliesTo.” This step can include attempting to separate the non-externalized string into words (e.g., by delimeters and/or by word recognition). If a non-externalized string includes a concatenated string, there is a possibility that the developer accidentally concatenated the string. If the non-externalized string is found to include concatenated words, then the process proceeds to step 814 and the non-externalized string is flagged as potentially incompatible with i18N requirements. Otherwise the process proceeds to step 808.

Step 808 is similar to step 812 except that it is applied to a single word non-externalized string. At step 808 the system determines whether the non-externalized string includes any formatting data. An example of strings with formatting data include “MM:DD:YYYY,” and “$.” Any kind of hardcoded time, date, currency, and/or locale specific data necessarily triggers i18N requirements. If the non-externalized string includes formatting data, then the process proceeds to step 815 and the non-externalized string is flagged as incompatible with i18N requirements. Otherwise the process proceeds to step 813, indicating that the non-externalized string does not require any internationalization and localization adjustments.

Referring back to FIG. 2, at step 204 the system determines whether at least one second instruction in the one or more second instructions does not comply with the internationalization and localization requirements based at least in part on a valid API repository and the one or more API signatures.

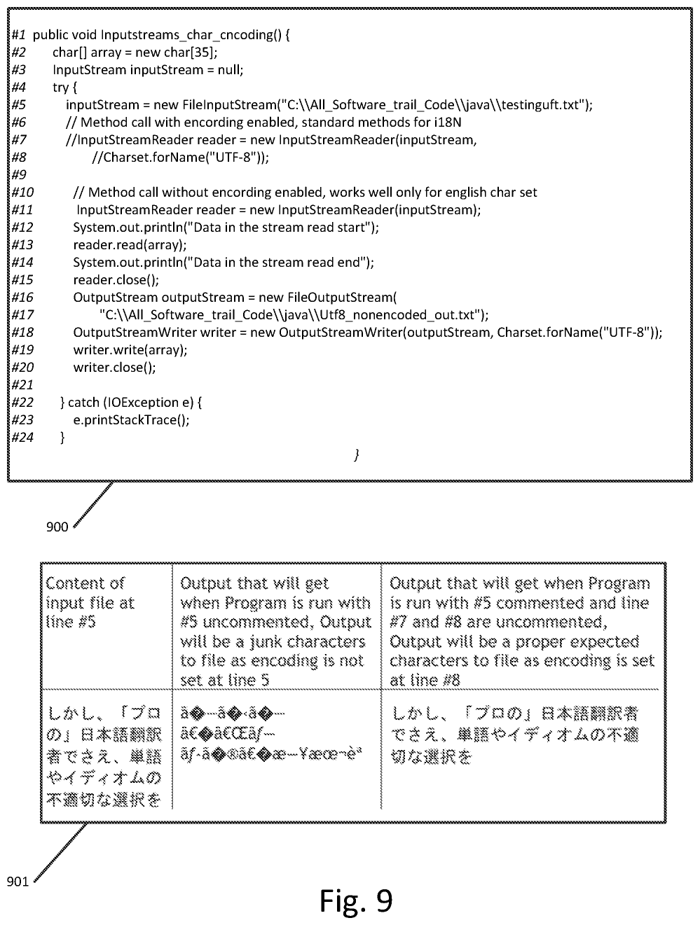

Prior to explaining this step in detail, it is important to understand the effects of API calls that do not follow i18N standards. FIG. 9 illustrates an example of assembly code having an API call and the output when the API call complies with i18N requirements and when the API call does not comply with i18N requirements according to an exemplary embodiment. Box 900 shows assembly code containing formatting API calls used without proper encoding standards with respect to i18N (line 5) and API calls that are used with the proper encoding standards with respect to i18N (lines 7-8).

Box 901 is a table showing the input and output to the assembly code with and without an i18N compliant API signature. The content of the input file is shown in the left-hand column. As shown in the center column of the table, when an i18N non-compliant API call is used, the output from the call is junk characters. However, when an i18N compliant API call is used, the proper expected characters are output, as shown in the right column of the table.

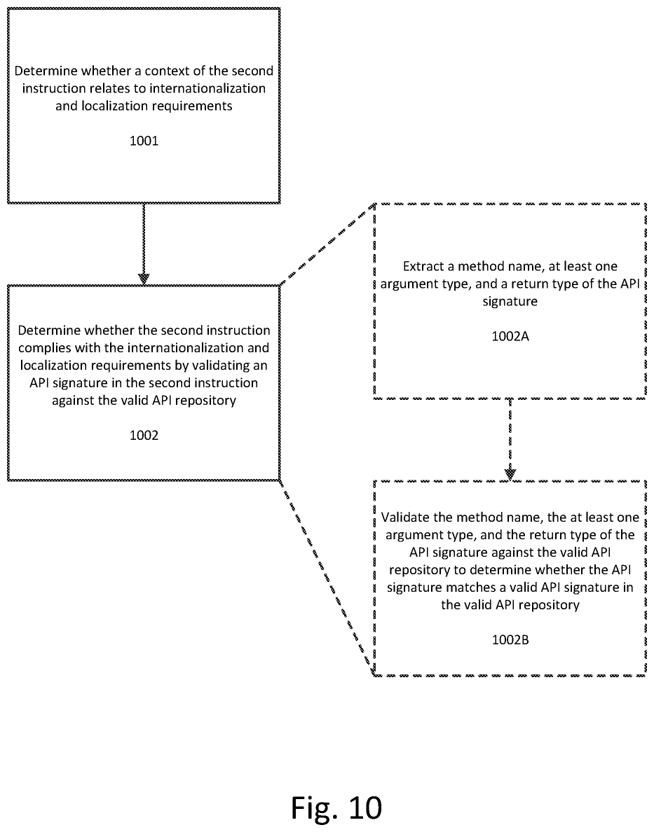

FIG. 10 illustrates a flowchart for determining whether at least one second instruction in the one or more second instructions does not comply with the internationalization and localization requirements based at least in part on a valid API repository and the one or more API signatures. The steps shown in FIG. 10 can be performed for each of the second instructions in the one or more second instructions.

At step 1001 the system determines whether a context of the second instruction relates to internationalization and localization requirements. This step can be performed by comparing fields, attributes, or other characteristics associated with the API signature with valid contexts indicated in a context repository, described in greater detail below. Valid i18N contexts can include messages, labels on GUI components, online help, sounds, colors, graphics, icons, dates, times, numbers, currencies, measurements, phone numbers, honorifics and personal titles, postal addresses, and/or page layouts. Certain fields and areas can be designated as not being relevant to i18N compliance. For example, a company may indicate that API signatures associated with log messages are not pertinent to i18N compliance and may disregard these API signatures.

Each of the lines for API calls/signatures (e.g., invoke, invokespecial, etc.) are checked for appropriate context. Specifically, the system will check if the API signatures (all signatures will have an Opcode like Invokespecial or Invokestatic etc) that are passed to it has an i18N context or not. If there is no i18N Context, then the API or method call will be rejected as not a legitimate API methods to validate. Otherwise, the methods signatures get stored in a set value type Object and are later used to identify the flaws in the code against the i18N standards.

At step 1002 the system determines whether the second instruction complies with the internationalization and localization requirements by validating an API signature in the second instruction against the valid API repository based at least in part on a determination that the context of the second instruction relates to internationalization and localization requirements.

Step 1002 can include sub-steps 1002A and 1002B. At step 1002A a method name, at least one argument type, and a return type of the API signature is extracted from the API signature. The API signature structure and information can be stored in a variety of possible data structures. One possible data structure for storing the API signature in Java is shown below:

```
“i18n_data”: {
    “java/io/InputStreamReader” {
    “Init” [{
        “expectedformat1”:
“java/io/InputStreamReader.”<init>“:(Ljava/io/InputStream;Ljava/nio/ch
arset/Charset;)V”
        },
    },
    “java/io/InputStreamWriter” {
    “Init” [{
        “expectedformat1” :
“java/io/OutputStreamWriter.”<init>“:(Ljava/to/OutputStream;Ljava/nio/
charset/Charset;)V”
      }
    }
  }
```

At step 1002B the method name, the at least one argument type, and the return type of the API signature are validated against the valid API repository to determine whether the API signature matches a valid API signature in the valid API repository.

The valid API repository forms a part of the system and stores information regarding classes, methods within those classes, and expected formats. This information is then compared against corresponding information extracted from API signatures in the assembly code to determine whether there is a deviation. The table below shows an example of a number of i18N methods under i18N classes for Java, along with examples of deviated API signatures. Similar methods and API information can be stored for other languages.

| | | | Deviated format for same methods if found |
|---|---|---|---|
| | | | will can cause issue in internalization |
| | | | operations, so must be avoided and will be |
| Java i18N classes | Java I18N methods | I18N expected Format in Opcode syntax | caught as an exception by system. |
| DateFormat | getDate | java/text/DateFormat.getDateTimeInstance: | java/text/DateFormat.getDateTimeInstance: |
| | TimeInstance | (IILjava/util/Locale;)Ljava/text/DateFormat; | (;)Ljava/text/DateFormat; |
| NumberFormat | getCurrencyInstance | java/text/NumberFormat.getCurrencyInstance: | java/text/NumberFormat.getCurrencyInstance: |
| | | (Ljava/util/Locale;)Ljava/text/NumberFormat; | (;)Ljava/text/NumberFormat; |
| DateFormat | getTimeInstance | java/text/DateFormat.getTimeInstance: | java/text/DateFormat.getTimeInstance: |
| | | (ILjava/util/Locale;)Ljava/text/DateFormat; | (ILjava/util/Locale;)Ljava/text/DateFormat; |
| Output | Constructor | java/io/OutputStreamWriter. “<init>”: | java/io/OutputStreamWriter. “<init>”: |
| Stream | type | (Ljava/io/OutputStream; Ljava/nio/charset/ | (Ljava/io/OutputStream;) V |
| Writer | | Charset;)V | |
| InputStreamReader | Constructor | java/io/InputStreamReader. “<init>”: | java/io/InputStreamReader. “<init>”: |
| | type | (Ljava/io/InputStream; Ljava/nio/charset/ | (Ljava/io/InputStream;) V |
| | | Charset;)V | |

The API repository can be updated as the system runs to determine whether a new method/API signature is a legitimate i18N API and not currently part of the repository. In this case, it can be added to the base repository.

The base repositories are created against various libs that are used for i18N against different languages common ones such as the ones indicated below and the repository can be distributed as part of a solution and continually updated.
ICU4j for Java
ICU4C for Assembly languages
Oracle for Java

These repositories store valid signatures of the API(Methods name, argument types and return types). These repositories will be placed at a common location and can be shared by the organization and the development team can contribute to this common repo.

API signatures can be stored in JSON format and can be stored in a format as shown above representing the signature of the method. The data can be stored as Key-Value (KV) pair in a database. This JSON can be stored, for example, in a NoSQL or SQL Database and can be read and write from there.

Algorithm 6 Pseudocode, reproduced below, takes the “Literal API data” that is created and validates it against a database of Standard API signatures in the valid API repository. The Database has all the expected formats and if the format matches with the input data set (e.g., the API data sets object) then data in the Object/API signature is considered valid. Otherwise the API signature is not validated and a determination is made that the API signature does not comply with internationalization and localization requirements.

Algorithm 6 Pseudocode:

| | |
|---|---|
| 1. | Script( @Pseudocode) in Previous shell #ARGUMENT $methodContextData |
| 2. | validate_i18N_Methods(methodContextData) |
| 3. | #set alldataset |
| 4. | #Data to load values of all methods signatures to see if the method defined has |
| | expected i18N format., #its a JSON file |
| 5. | Jsoni18NSignatureData=Load exception list data file. |
| 6. | #Parse the classIncontext and methodInContext from methodContextData, Regex |
| | parsing with “:” as seperator. |
| 7. | verify classIncontext and methodInContext in Jsoni18NSignatureData as Regex, |
| | keys present or not. |
| 8. | #if Key is found then get the Value from it and compare with the value of |
| | Jsoni18NSignatureData |
| 9. | String |
| | sValueWithSignature=methodContextData.get(classIncontext:methodInContext:classname:classMet |
| | hodName_$rndNo) |
| 10. | #Compare the signature, class name, method name, arguments type and |
| | return type. like value at sValueWithSignature say: |
| | java/util/Currency.getInstance:(Ljava/util/Locale;)Ljava/util/Currency format compares with value |
| | at Jsoni18NSignatureData(Class.methodname) say |
| | java/util/Currency.getInstance:(Ljava/util/Locale;)Ljava/util/Currency, we follow the i18N standard |
| | given. |
| 11. | if (compare) |
| 12. | echo “ All good: Method signature used is same as expected by |
| | i18N standards” |
| 13. | else |
| 14. | echo “fail:Method signature used is not same as expected by i18N |
| | standards” |
| 15. | Push the data to DB( mostly Elastic search), with i18N |
| | noncompliance issues. |

Background processes can add to the valid API repository by reading the compiled libraries, capturing the signatures, and storing back to the repository. For example, in JVM based languages, a reflection framework can be used that has capability to read the data structure \metadata from compiled libraries can store it in an appropriate structure. The content can be stored as a Key Value pair, where the Key is the classcontext and methodcontent and the Value is the different methods signatures and parts of the signature such as return type, arguments, and corresponding types.

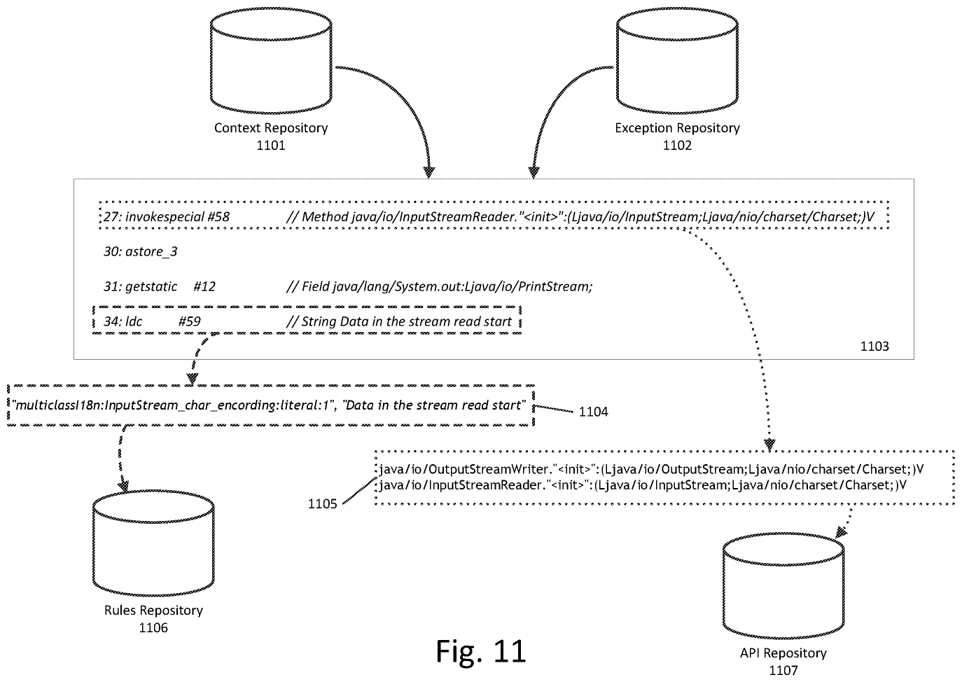

FIG. 11 illustrates an example of assembly code parsing and processing according to an exemplary embodiment. As shown in FIG. 11, the assembly code 1103 is parsed to identify code having non-externalized strings (shown in dashed lines, 1104) and code having API signatures (shown in dotted lines, 1105). The context repository 1101 and the exception repository 1102 are applied to the parsed code to determine whether an exception applies and whether the context is a valid i18N context. If the instructions/code having non-externalized strings (1104) and instructions/code having API signatures (1105) has a valid i18N context and is not considered an exception, then the literal string data and the literal API data can be passed to a validation step, such as in JSON format. In the validation step, the rules repository 1106 can be applied to non-externalized string code (1104) and the API repository (1107) can be applied to code having API signatures (1105) to determine whether the instructions/code comply with internationalization and localization requirements. These processes are described above.

Returning to FIG. 2, at step 205 a mitigation action is executed on the source code based at least in part on a determination that at least one of the one or more first instructions does not comply with the internationalization and localization requirements or a determination that at least one of the one of the one or more second instructions does not comply with the internationalization and localization requirements.

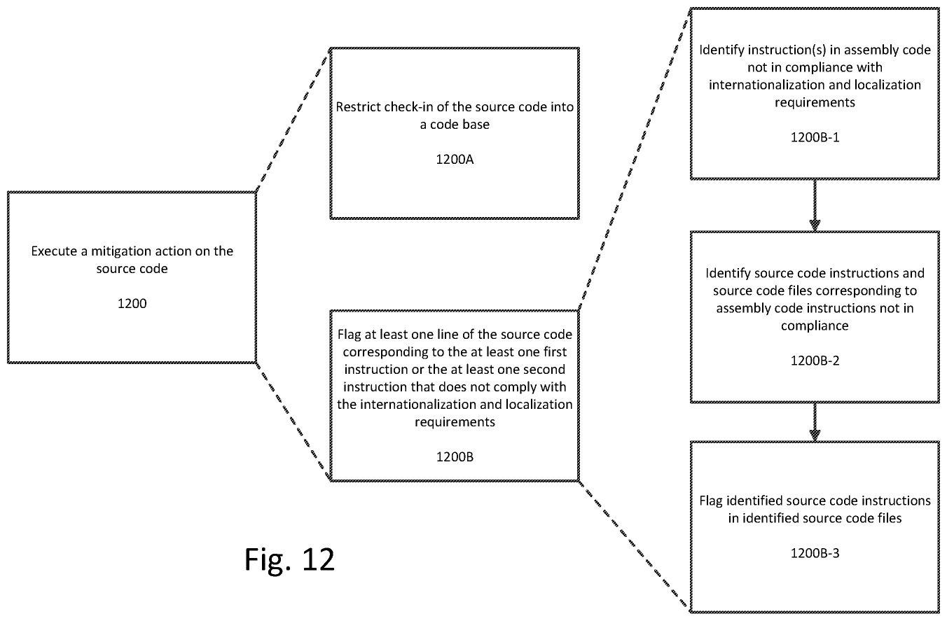

FIG. 12 illustrates a flowchart for executing a mitigation action on the source code according to an exemplary embodiment. Of course, multiple mitigation actions can be executed on the source code as well.

At step 1200 a mitigation action is executed on the source code. As shown in step 1200A, the mitigation action can be restricting check-in of the source code, the latest version of the source code, or the affected portions of the source code into a code base until the source code is modified to remove the portions of source code that are incompatible with internationalization and localization requirements. This mitigation action can be reserved for scenarios where there is a high likelihood that an instruction does not comply with the internationalization and localization requirements. For example, this mitigation can be executed in response to the process reaching step 815 in FIG. 8.

As indicated in step 1200B, the mitigation action can also be flagging at least one line of the source code corresponding to the at least one first instruction or the at least one second instruction that does not comply with the internationalization and localization requirements. This mitigation action can be used in conjunction with the mitigation action of restricting check-in of the source code. Alternatively, this mitigation action can be used when there are potential incompatibilities with internationalization and localization requirements but without restricting check-in. In this case, the relevant source code lines can be flagged for the developer, and if the developer approves or elects to ignore the source code flags, then the code can be checked-in.

At step 1200B-1, which is part of step 1200B, instructions in the assembly code that are not in compliance with internationalization and localization requirements are identified. At step 1200B-2 source code instructions and source code files corresponding to the assembly code instructions not in compliance are identified. The relevant source code lines can be identified using a LineNumberTable data structure, shown below:

| | | Syntax (From actual Bytecode |
|---|---|---|
| Opcode | Description | of a sample program) |
| Linenumbertable | This is a parameters in bytecode | LineNumberTable: |
| | file that maps the source code | line 42: 0 |
| | with statements in bytecode for | line 44: 8 |
| | a given statement. This helps | line 45: 19 |
| | us to map the changed line by | Left side before “:” is line at code |
| | dev to bytecode and do the | and right side is line at bytecode. |
| | required analysis only on | |
| | those lines | |

As shown above, the LineNumberTable data structure maps lines of source code to lines of assembly code. When instructions in the assembly code are identified that do not comply with the internationalization and localization requirements, the LineNumberTable data structure can be used to identify the corresponding lines in the source code that do not comply with the internationalization and localization requirements.

At step 1200B-3, these lines can then be flagged for the developer in the native source code interface. The developer can then be given various options to respond to the flagged lines. For example, the developer can be prompted to make changes to the source code, to ignore the flagged issues and continue with check in of the code, to mark certain non-externalized strings or API calls/functions as exceptions, or other response options.

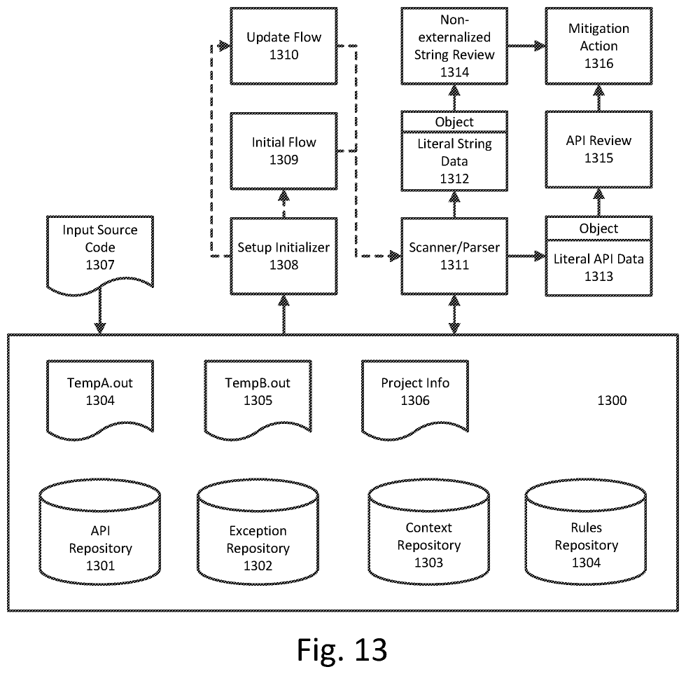

FIG. 13 illustrates a system chart of a system for mitigating noncompliance of source code with internationalization and localization requirements according to an exemplary embodiment.

Input source 1307 is provided as the initial input to the system. The system includes a storage 1300 that stores temporary files 1304 and 1305, project information 1306 relating to the code base, the valid API repository 1301, the exception repository 1302, the context repository 1303, and the rules repository 1304.

A setup initializer 1308 is used to identify code in a code repository that has changed or new source code files and/or detect when a developer has submitted source and then trigger downstream steps. Setup initializer 1308 can then trigger initial flow 1309 (for the first time the code is processed) or update flow 1310 (for updated code) to identify the target assembly code. Scanner/parser 1311 evaluates the target assembly code to identify literal string data 1312 and literal API data 1313 for further evaluation for compliance with internationalization and localization requirements. Literal string data 1312 is passed to non-externalized string review software 1314 and literal API data is passed to API review software 1315. If non-externalized strings or API signatures are found to not comply with the internationalization and localization requirements, then at mitigation action software 1316 initiates a mitigation action, as discussed previously.

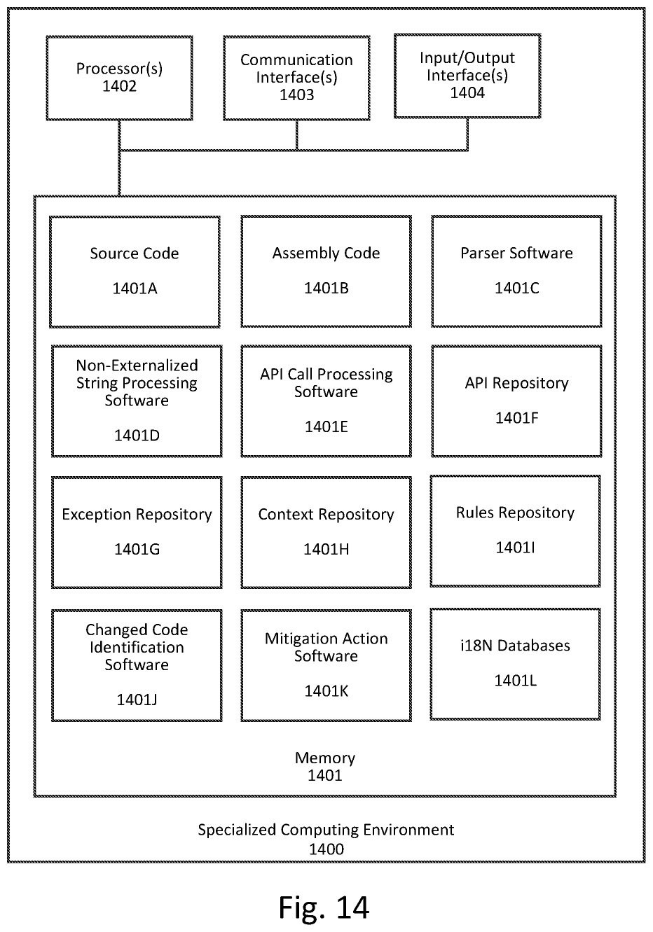

FIG. 14 illustrates the components of the specialized computing environment 1400 configured to perform the processes described herein according to an exemplary embodiment. Specialized computing environment 1400 is a computing device that includes a memory 1401 that is a non-transitory computer-readable medium and can be volatile memory (e.g., registers, cache, RAM), non-volatile memory (e.g., ROM, EEPROM, flash memory, etc.), or some combination of the two.

As shown in FIG. 14, memory 1401 can include source code 1401A, assembly code 1401B, parser software 1401C, non-externalized string processing software 1401D, API Call Processing Software 1401E, API Repository 1401F, Exception Repository 1401G, Context Repository 1401H, Rules Repository 1401I, Changed Code Identification Software 1401J, Mitigation Action Software 1401K, and i18N Databases 1401L.

Each of the program and software components in memory 1401 store specialized instructions and data structures configured to perform the corresponding functionality and techniques described herein.

All of the software stored within memory 1401 can be stored as a computer-readable instructions, that when executed by one or more processors 1402, cause the processors to perform the functionality described with respect to FIGS. 2-13.

Processor(s) 1402 execute computer-executable instructions and can be a real or virtual processors. In a multi-processing system, multiple processors or multicore processors can be used to execute computer-executable instructions to increase processing power and/or to execute certain software in parallel.

Specialized computing environment 1400 additionally includes a communication interface 1403, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 1400 further includes input and output interfaces 1404 that allow users (such as system administrators) to provide input to the system to display information, to edit data stored in memory 1401, or to perform other administrative functions.

An interconnection mechanism (shown as a solid line in FIG. 14), such as a bus, controller, or network interconnects the components of the specialized computing environment 1400.

Input and output interfaces 1404 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 1400.

Specialized computing environment 1400 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 1400.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for mitigating noncompliance of source code with internationalization and localization requirements, the method comprising:
compiling target source code to generate target assembly code, the target assembly code comprising a plurality of instructions having a plurality of associated operation codes;
parsing the target assembly code to identify one or more first instructions corresponding to one or more non-externalized string values based at least in part on one or more first operation codes associated with the one or more first instructions;
parsing the target assembly code to identify one or more second instructions corresponding to one or more Application Programming Interface (API) signatures based at least in part on one or more second operation codes associated with the one or more second instructions;
determining whether at least one first instruction in the one or more first instructions does not comply with the internationalization and localization requirements based at least in part on the one or more non-externalized string values;
determining whether at least one second instruction in the one or more second instructions does not comply with the internationalization and localization requirements based at least in part on a valid API repository and the one or more API signatures; and
executing a mitigation action on the source code based at least in part on a determination that at least one of the one or more first instructions does not comply with the internationalization and localization requirements or a determination that at least one of the one of the one or more second instructions does not comply with the internationalization and localization requirements.

2. The method of claim 1, wherein compiling target source code to generate target assembly code comprises:
receiving a current version of a source code library;
comparing the current version of the source code library with a previous version of the source code library to identify new source code;
determining the target source code based at least in part on the new source code;
compiling the target source code to generate a current version of assembly code;
identifying new assembly code based at least in part on the current version of assembly code; and
designating the new assembly code as the target assembly code.

3. The method of claim 1, wherein determining whether at least one first instruction in the one or more first instructions does not comply with the internationalization and localization requirements based at least in part on the one or more non-externalized string values comprises, for each first instruction:
determining whether a non-externalized string value corresponding to the first instruction corresponds to an exception in one or more exceptions;
determining whether the non-externalized string value complies with internationalization and localization requirements based at least in part on a determination that the non-externalized string value does not correspond to an exception in the one or more exceptions.

4. The method of claim 3, wherein determining whether the non-externalized string value complies with internationalization and localization requirements comprises:
applying one or more non-externalized string rules to the non-externalized string value; and
designating the non-externalized string value as either incompatible with internationalization and localization requirements or potentially incompatible with internationalization and localization requirements based at least in part on applying the one or more non-externalized string rules to the non-externalized string value.

5. The method of claim 1, wherein determining whether at least one second instruction in the one or more second instructions does not comply with the internationalization and localization requirements based at least in part on a valid API repository and the one or more API signatures comprises, for each second instruction:
determining whether a context of the second instruction relates to internationalization and localization requirements; and
determining whether the second instruction complies with the internationalization and localization requirements by validating an API signature in the second instruction against the valid API repository based at least in part on a determination that the context of the second instruction relates to internationalization and localization requirements.

6. The method of claim 5, wherein determining whether the second instruction complies with the internationalization and localization requirements by validating an API signature in the second instruction against the valid API repository comprises:
extracting a method name, at least one argument type, and a return type of the API signature; and
validating the method name, the at least one argument type, and the return type of the API signature against the valid API repository to determine whether the API signature matches a valid API signature in the valid API repository.

7. The method of claim 1, wherein executing a mitigation action on the source code comprises one or more of:
restricting check-in of the source code into a code base; or
flagging at least one line of the source code corresponding to the at least one first instruction or the at least one second instruction that does not comply with the internationalization and localization requirements.

8. An apparatus for mitigating noncompliance of source code with internationalization and localization requirements, the apparatus comprising:
one or more processors; and
one or more memories operatively coupled to at least one of the one or more processors and having instructions stored thereon that, when executed by at least one of the one or more processors, cause at least one of the one or more processors to:
compile target source code to generate target assembly code, the target assembly code comprising a plurality of instructions having a plurality of associated operation codes;
parse the target assembly code to identify one or more first instructions corresponding to one or more non-externalized string values based at least in part on one or more first operation codes associated with the one or more first instructions;
parse the target assembly code to identify one or more second instructions corresponding to one or more Application Programming Interface (API) signatures based at least in part on one or more second operation codes associated with the one or more second instructions;
determine whether at least one first instruction in the one or more first instructions does not comply with the internationalization and localization requirements based at least in part on the one or more non-externalized string values;
determine whether at least one second instruction in the one or more second instructions does not comply with the internationalization and localization requirements based at least in part on a valid API repository and the one or more API signatures; and
execute a mitigation action on the source code based at least in part on a determination that at least one of the one or more first instructions does not comply with the internationalization and localization requirements or a determination that at least one of the one of the one or more second instructions does not comply with the internationalization and localization requirements.

9. The apparatus of claim 8, wherein the instructions that, when executed by at least one of the one or more processors, cause at least one of the one or more processors to compile target source code to generate target assembly code further cause at least one of the one or more processors to:
receive a current version of a source code library;
compare the current version of the source code library with a previous version of the source code library to identify new source code;
determine the target source code based at least in part on the new source code;
compile the target source code to generate a current version of assembly code;
identify new assembly code based at least in part on the current version of assembly code; and
designate the new assembly code as the target assembly code.

10. The apparatus of claim 8, wherein the instructions that, when executed by at least one of the one or more processors, cause at least one of the one or more processors to determine whether at least one first instruction in the one or more first instructions does not comply with the internationalization and localization requirements based at least in part on the one or more non-externalized string values further cause at least one of the one or more processors to, for each first instruction:
determine whether a non-externalized string value corresponding to the first instruction corresponds to an exception in one or more exceptions;
determine whether the non-externalized string value complies with internationalization and localization requirements based at least in part on a determination that the non-externalized string value does not correspond to an exception in the one or more exceptions.

11. The apparatus of claim 10, wherein the instructions that, when executed by at least one of the one or more processors, cause at least one of the one or more processors to determine whether the non-externalized string value complies with internationalization and localization requirements further cause at least one of the one or more processors to:
apply one or more non-externalized string rules to the non-externalized string value; and
designate the non-externalized string value as either incompatible with internationalization and localization requirements or potentially incompatible with internationalization and localization requirements based at least in part on applying the one or more non-externalized string rules to the non-externalized string value.

12. The apparatus of claim 8, wherein the instructions that, when executed by at least one of the one or more processors, cause at least one of the one or more processors to determine whether at least one second instruction in the one or more second instructions does not comply with the internationalization and localization requirements based at least in part on a valid API repository and the one or more API signatures further cause at least one of the one or more processors to, for each second instruction:
determine whether a context of the second instruction relates to internationalization and localization requirements; and
determine whether the second instruction complies with the internationalization and localization requirements by validating an API signature in the second instruction against the valid API repository based at least in part on a determination that the context of the second instruction relates to internationalization and localization requirements.

13. The apparatus of claim 12, wherein the instructions that, when executed by at least one of the one or more processors, cause at least one of the one or more processors to determine whether the second instruction complies with the internationalization and localization requirements by validating an API signature in the second instruction against the valid API repository further cause at least one of the one or more processors to:
extract a method name, at least one argument type, and a return type of the API signature; and
validate the method name, the at least one argument type, and the return type of the API signature against the valid API repository to determine whether the API signature matches a valid API signature in the valid API repository.

14. The apparatus of claim 8, wherein the instructions that, when executed by at least one of the one or more processors, cause at least one of the one or more processors to execute a mitigation action on the source code further cause at least one of the one or more processors to perform one or more of:
restrict check-in of the source code into a code base; or
flag at least one line of the source code corresponding to the at least one first instruction or the at least one second instruction that does not comply with the internationalization and localization requirements.

15. At least one non-transitory computer-readable medium storing computer-readable instructions for mitigating noncompliance of source code with internationalization and localization requirements that, when executed by one or more computing devices, cause at least one of the one or more computing devices to:
compile target source code to generate target assembly code, the target assembly code comprising a plurality of instructions having a plurality of associated operation codes;
parse the target assembly code to identify one or more first instructions corresponding to one or more non-externalized string values based at least in part on one or more first operation codes associated with the one or more first instructions;
parse the target assembly code to identify one or more second instructions corresponding to one or more Application Programming Interface (API) signatures based at least in part on one or more second operation codes associated with the one or more second instructions;
determine whether at least one first instruction in the one or more first instructions does not comply with the internationalization and localization requirements based at least in part on the one or more non-externalized string values;
determine whether at least one second instruction in the one or more second instructions does not comply with the internationalization and localization requirements based at least in part on a valid API repository and the one or more API signatures; and
execute a mitigation action on the source code based at least in part on a determination that at least one of the one or more first instructions does not comply with the internationalization and localization requirements or a determination that at least one of the one of the one or more second instructions does not comply with the internationalization and localization requirements.

16. The at least one non-transitory computer-readable medium of claim 15, wherein the instructions that, when executed by at least one of the one or more computing devices, cause at least one of the one or more computing devices to compile target source code to generate target assembly code further cause at least one of the one or more computing devices to:
receive a current version of a source code library;
compare the current version of the source code library with a previous version of the source code library to identify new source code;
determine the target source code based at least in part on the new source code;
compile the target source code to generate a current version of assembly code;
identify new assembly code based at least in part on the current version of assembly code; and
designate the new assembly code as the target assembly code.

17. The at least one non-transitory computer-readable medium of claim 15, wherein the instructions that, when executed by at least one of the one or more computing devices, cause at least one of the one or more computing devices to determine whether at least one first instruction in the one or more first instructions does not comply with the internationalization and localization requirements based at least in part on the one or more non-externalized string values further cause at least one of the one or more computing devices to, for each first instruction:
determine whether a non-externalized string value corresponding to the first instruction corresponds to an exception in one or more exceptions;
determine whether the non-externalized string value complies with internationalization and localization requirements based at least in part on a determination that the non-externalized string value does not correspond to an exception in the one or more exceptions.

18. The at least one non-transitory computer-readable medium of claim 17, wherein the instructions that, when executed by at least one of the one or more computing devices, cause at least one of the one or more computing devices to determine whether the non-externalized string value complies with internationalization and localization requirements further cause at least one of the one or more computing devices to:
apply one or more non-externalized string rules to the non-externalized string value; and
designate the non-externalized string value as either incompatible with internationalization and localization requirements or potentially incompatible with internationalization and localization requirements based at least in part on applying the one or more non-externalized string rules to the non-externalized string value.

19. The at least one non-transitory computer-readable medium of claim 15, wherein the instructions that, when executed by at least one of the one or more computing devices, cause at least one of the one or more computing devices to determine whether at least one second instruction in the one or more second instructions does not comply with the internationalization and localization requirements based at least in part on a valid API repository and the one or more API signatures further cause at least one of the one or more computing devices to, for each second instruction:
determine whether a context of the second instruction relates to internationalization and localization requirements; and
determine whether the second instruction complies with the internationalization and localization requirements by validating an API signature in the second instruction against the valid API repository based at least in part on a determination that the context of the second instruction relates to internationalization and localization requirements.

20. The at least one non-transitory computer-readable medium of claim 19, wherein the instructions that, when executed by at least one of the one or more computing devices, cause at least one of the one or more computing devices to determine whether the second instruction complies with the internationalization and localization requirements by validating an API signature in the second instruction against the valid API repository further cause at least one of the one or more computing devices to:
extract a method name, at least one argument type, and a return type of the API signature; and
validate the method name, the at least one argument type, and the return type of the API signature against the valid API repository to determine whether the API signature matches a valid API signature in the valid API repository.

21. The at least one non-transitory computer-readable medium of claim 15, wherein the instructions that, when executed by at least one of the one or more computing devices, cause at least one of the one or more computing devices to execute a mitigation action on the source code further cause at least one of the one or more computing devices to perform one or more of:
restrict check-in of the source code into a code base; or
flag at least one line of the source code corresponding to the at least one first instruction or the at least one second instruction that does not comply with the internationalization and localization requirements.
